(19) United States
(12) Patent Application Publication
(10) Pub. No.: US 2013/0209054 A1
(43) Pub. Date: Aug. 15, 2013

(54) Hunter Video Recording Signal System

(71) Applicant: Mark Woolard, Morristown, TN (US)

(72) Inventor: Mark Woolard, Morristown, TN (US)

(21) Appl. No.: 13/764,212

(22) Filed: Feb. 11, 2013

Related U.S. Application Data
(60) Provisional application No. 61/596,923, filed on Feb. 9, 2012.

(51) Int. Cl. H04N 9/79

(52) U.S. Cl. CPC H04N 9/79
USPC 386/224

(57) ABSTRACT

An electronic signal system, to use in video recording game hunting, for the camera operator to communicate to the hunter, without potentially “spooking” the targeted animal or alerting the targeted animal to the presence of the camera operator and hunter, that the camera operator has a clear video view of the targeted animal.

### CROSS-REFERENCE TO RELATED APPLICATIONS

This Application claims priority under 35 U.S.C. §119(e) to U.S. Provisional Patent Application Ser. No. 61/596,923, filed Feb. 9, 2012.

### STATEMENT REGARDING FEDERALLY SPONSORED RESEARCH OR DEVELOPMENT

Not Applicable

### BACKGROUND OF THE INVENTION

1. Field of Invention

This invention pertains generally to equipment for use in video recording game hunting. More particularly, this invention pertains to a signal device for communication between a camera operator and a hunter during game hunting.

2. Description of the Related Art

In many hunting shows and televised programs (“hunting shows”), a hunter (i.e., the person operating a weapon in order to kill prey) asks a nearby camera operator, “Are you ready?” In asking the above-referenced question, the hunter is seeking to ensure that the camera operator or video recorder (hereinafter, simply “camera operator”) has a clear view of the targeted animal before the hunter looses an arrow or fires a bullet or slug at the targeted animal. Hunters and camera operators producing footage for hunting shows endeavor to capture good footage, including clear video of “kill shots” (i.e., the arrow, bullet, slug, or other projectile hitting and wounding the targeted animal). However, voice communication between the hunter and the camera operator can alert the targeted animal to the presence of human beings, and the targeted animal may then flee the vicinity, preventing the hunter from achieving success in killing the targeted animal.

It is desirable to have a system for the camera operator to communicate with the hunter without potentially “spooking” the targeted animal or alerting the targeted animal to the presence of the camera operator and hunter.

BRIEF SUMMARY INVENTION

In some of its many embodiments, the present general inventive concept comprises a substantially silent electronic signal system for the camera operator to communicate to the hunter that the camera operator has a clear video view of the targeted animal, without potentially “spooking” the targeted animal or alerting the targeted animal to the presence of the camera operator and hunter. A hunter video recording signal system according to the present general inventive concept generally comprises

In some of its several embodiments, present general inventive provides a hunter video recording signal system including a transmitter to transmit a signal from a camera operator to a hunter to indicate that the camera operator has a clear video view of a target annual, a receiver to receive the signal transmitted by said transmitter, and an indicator in communication with said receiver and activated by said receiver when said receiver receives a signal transmitted by said transmitter, said indicator being positioned near the sight of a hunter's weapon, said indicator to change between a first state and a second state, the second state of said indicator to alert a hunter that the camera operator is in a position to record a shot by the hunter, said indicator changing from the first state and the second state when said indicator is activated by said receiver.

In many embodiments of the present invention, the indicator comprises a light, which lights up, flashes, or turns a different color when the receiver receives a “clear video view ready” signal from the camera operator's transmitter. In some particular embodiments, the indicator is a green light positioned near the sight, scope, telescopic sight, laser sight, or other sighting device of the hunter's weapon; a small bulb becomes illuminated and emits green light when the receiver receives a “clear video view ready” signal from the transmitter. In some embodiments, the indicator has various forms, including, but not limited to, a device that delivers an audio signal to the hunter, for example through an earpiece worn by the hunter.

In some of its several embodiments, present general inventive provides a hunter video recording signal system including a transmitter to transmit a signal from a camera operator to a hunter to indicate that the camera operator has a clear video view of a target animal, a receiver to receive the signal transmitted by said transmitter, and a visual indicator device to alert a hunter that the camera operator is in a position to record a shot by the hunter.

A hunter video recording signal system according to the present general inventive concept is capable of being used with a variety of hunting weapons, including, but not limited to, bows, rifles, shotguns, muzzle-loading firearms, crossbows, pistols, and similar weapons.

Generally, during the process of video recording the hunting of a game animal, a camera operator is positioned so that the camera operator has a clear view of the targeted animal. The camera operator, operating a transmitter, transmits a substantially silent signal to a receiver. The receiver receives the signal from said transmitter, and said receiver activates an indicator to alert a hunter that the camera operator is in a position to record a shot by the hunter.

Thus, in some of its several example embodiments, the present general inventive concept provides a substantially silent electronic system for the camera operator to communicate with the hunter without potentially “spooking” the targeted animal or alerting the targeted animal to the presence of the camera operator and hunter.

### BRIEF DESCRIPTION OF THE DRAWINGS

The above-mentioned and additional features of the invention will become more clearly understood from the following detailed description of the invention read together with the drawings in which:

FIG. 1 is a perspective view of one example embodiment of a hunter video recording signal system, showing communication between a camera operator and a hunter in the process of hunting a game animal;

FIG. 2 is block diagram view of one example embodiment of a hunter video recording signal system;

FIG. 3 is a perspective view of one example embodiment of a bow with a receiver and visual indicator device attached to the bow; and

FIG. 4 is close-up perspective view of the receiver and visual indicator device shown in FIG. 3.

### DETAILED DESCRIPTION OF THE INVENTION

In some of its many embodiments, the present general inventive concept comprises a substantially silent electronic system for the camera operator to communicate with the hunter without potentially “spooking” the targeted animal or alerting the targeted animal to the presence of the camera operator and hunter.

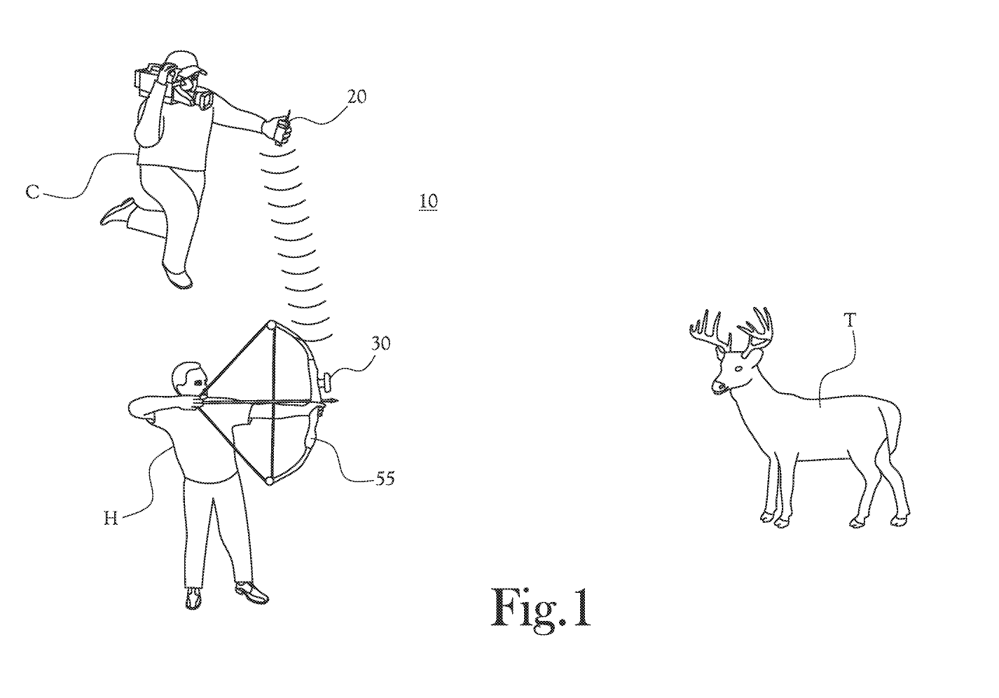

FIG. 1 illustrates one example embodiment of a system according to the present invention. In some example embodiments of a system according to the present general inventive concept, a hunter video recording signal system 10 comprises a transmitter 20, a receiver 30, and an indicator 40. During the process of video recording the hunting of a game animal, a camera operator C positions himself or herself so that the camera operator C has a clear view of a targeted animal T and is thereby able to record with video-recording equipment the death of said targeted animal T. At this point, the camera operator C has a “clear video view” of the targeted animal T. When the camera operator C has a clear video view of the targeted animal T and all relevant video-recording equipment is ready, then the camera operator C is ready to record the “kill shot” delivered by a hunter H. When the camera operator C has a clear video view of the targeted animal T, the camera operator C uses the transmitter 20 to send a signal to the receiver 30. When the receiver 30 receives the signal from the transmitter 20, the receiver 30 activates an indicator 40, which alerts the hunter H that the camera operator C is ready to record a kill shot. The hunter H is then free to take the kill shot, which the camera operator C records. Use of a hunter video recording signal system such as the system 10 allows the camera operator C to communicate with the hunter H without speaking or making other noises or movements that might spook the targeted animal T.

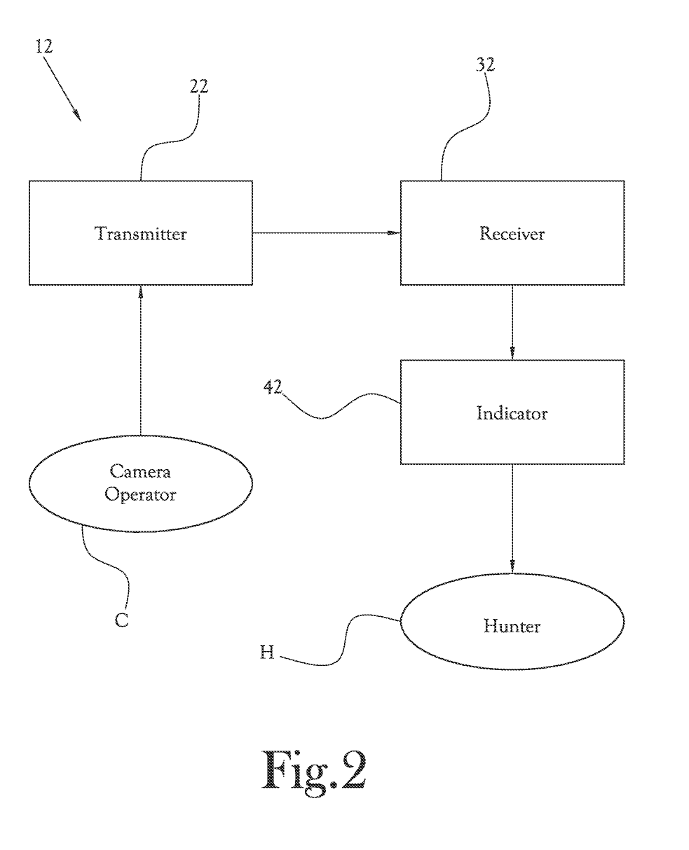

FIG. 2 is a block diagram illustrating the relationship between components of one example embodiment of a hunter video recording signal system according to the present general inventive concept. In the illustrated example embodiment, an example embodiment hunter video recording signal system 12 comprises a transmitter 22, a receiver 32, and an indicator 42. During the process of video recording the hunting of a game animal, a camera operator C positions himself or herself so that the camera operator C has a clear video view of a targeted animal. When the camera operator C has a clear video view of the targeted animal and is ready to record the “kill shot” delivered by a hunter H, the camera operator C uses the transmitter 22 to send a signal to the receiver 32. When the receiver 32 receives the signal from the transmitter 22, the receiver 32 activates an indicator 42, which alerts the hunter H that the camera operator C is ready to record a kill shot. The hunter H is then free to take the kill shot, which the camera operator C records. Use of a hunter video recording signal system such as the system 12 allows the camera operator C to communicate with the hunter H without speaking or making other noises or movements that might spook the targeted animal.

In many embodiments of the present invention, the indicator comprises a light, which lights up, flashes, or turns a different color when the receiver receives a “clear video view ready” signal from the camera operator's transmitter. In some particular embodiments, the indicator is a green light positioned near the sight, scope, telescopic sight, laser sight, or other sighting device of the hunter's weapon; a small bulb becomes illuminated and emits green light when the receiver receives a “clear video view ready” signal from the transmitter. In some embodiments, the indicator has various forms, including, but not limited to, a device that delivers an audio signal to the hunter, for example through an earpiece worn by the hunter.

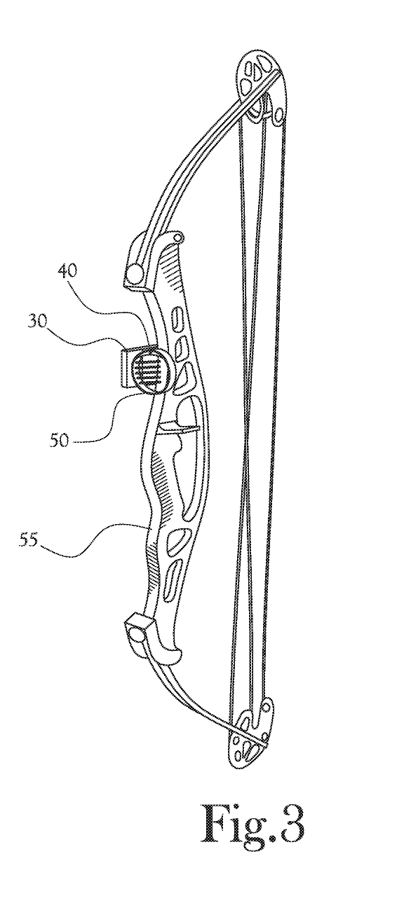

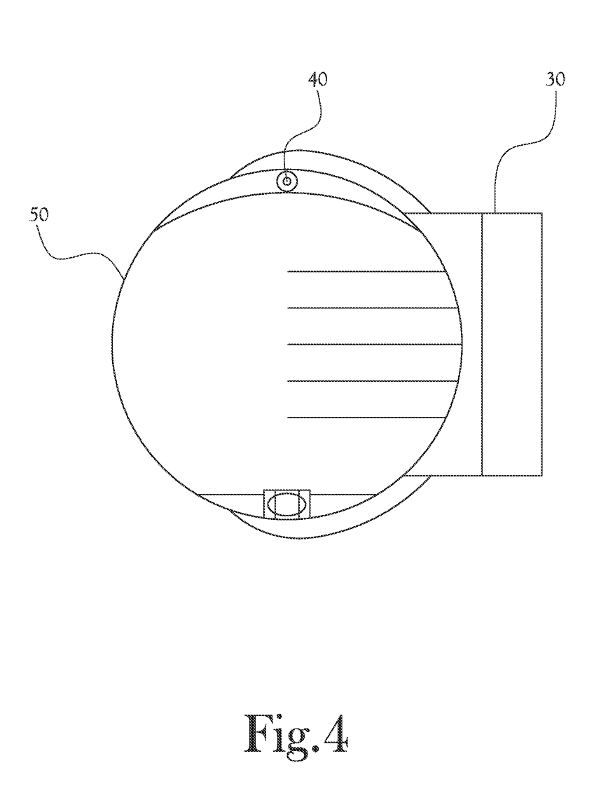

FIG. 3 illustrates one example embodiment of a bow 55 with a receiver 30 and visual indicator device 40 attached to the bow 55. As shown in FIG. 3 and in the closer view in FIG. 4 of the sight 50 with receiver 30 and visual indicator device 40, in the illustrated example embodiment, the bow 55 includes a sight 50, and the receiver 30, positioned near the sight 50 or attached to the sight 50, delivers a command to the visual indicator device 40 when the receiver 30 receives a “clear video view ready” signal from a transmitter. In the illustrated example embodiment, the visual indicator device 40 comprises a green light positioned close above the sight 50; the green light becomes illuminated to tell the hunter that the camera operator has a clear video view of the target animal and is ready to record the kill shot.

Although in several of the illustrated example embodiments described above, a hunter video recording signal system is used in conjunction with a bow, for use in bow hunting, a hunter video recording signal system according to the present general inventive concept could also be used with other hunting weapons, including, but not limited to, rifles, shotguns, muzzle-loading firearms, crossbows, pistols, and similar weapons. Additional uses and embodiments, falling within the scope of the present invention, will occur to those of skill in the art.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A hunter video recording signal system comprising:
a transmitter to transmit a signal from a camera operator to a hunter to indicate that the camera operator has a clear video view of a target animal;
a receiver the signal transmitted by said transmitter;
an indicator in communication with said receiver and activated by said receiver when said receiver receives a signal transmitted by said transmitter, said indicator being positioned near the sight of a hunter's weapon, said indicator to change between a first state and a second state, the second state of said indicator to alert a hunter that the camera operator is in a position to record a shot by the hunter, said indicator changing from the first state and the second state when said indicator is activated by said receiver.

2. The hunter video recording signal system of claim 1 wherein said indicator is a light.

3. The hunter video recording signal system of claim 2 wherein said indicator is a light positioned near the scope of the hunting weapon.

4. The hunter video recording signal system of claim 2 wherein said indicator is a light positioned near the top of the scope of the hunting weapon.

5. The hunter video recording signal system of claim 2 wherein said indicator is a green light.

6. The hunter video recording signal system of claim 1 wherein said receiver and said indicator are used with a bow.

7. The hunter video recording signal system of claim 1 wherein said receiver and said indicator are used with a rifle.

8. The hunter video recording signal system of claim 1 herein said receiver and said indicator are used with a shotgun.

9. The hunter video recording signal system of claim 1 wherein said receiver and said indicator are used with a muzzle-loading firearm.

10. The hunter video recording signal system of claim 1 wherein said receiver and said indicator are used with a crossbow.

11. A hunter video recording signal system comprising:
a transmitter to transmit a signal from a camera operator to a hunter to indicate that the camera operator has a clear video view of a target animal;
a receiver to receive the signal transmitted by said transmitter;
a visual indicator device to alert a hunter that the camera operator is in a position to record a shot by the hunter.

12. The hunter video recording signal system of claim 11 wherein said visual indicator device is a light.

13. The hunter video recording signal system of claim 12 wherein said visual indicator device is a light positioned near the scope of the hunting weapon.

14. The hunter video recording signal system of claim 12 wherein said visual indicator device is a light positioned near the top of the scope of the hunting weapon.

15. The hunter video recording signal system of claim 12 wherein said visual indicator device is a green light.

16. The hunter video recording signal system of claim 11 wherein said receiver and said visual indicator device are used with one of a bow, rifle, shotgun, muzzle-loading firearm, or crossbow.

17. A method of substantially silent communication between a camera operator and a hunter during a video-recorded hunting session comprising:
a camera operator being positioned so that the camera operator has a clear view of a targeted animal;
the camera operator operating a transmitter o transmit a substantially silent signal to a receiver;
said receiver receiving the signal from said transmitter;
said receiver activating an indicator to alert a hunter that the camera operator is in a position to record a shot by the hunter.
